(19) United States
(12) Patent Application Publication
(10) Pub. No.: US 2010/0018604 A1
(43) Pub. Date: Jan. 28, 2010

(54) SAFETY DEVICE FOR FUEL DISPENSING NOZZLES

(75) Inventor: Galliano Bentivoglio, Bologna (IT)

Correspondence Address: TUTUNJIAN + BITETTO, P.C., 20 CROSSWAYS PARK NORTH, SUITE 210, WOODBURY, NY, 11797, US

(73) Assignee: NOZZEL ENG. S.R.L., Saronno (IT)

(21) Appl. No.: 12/306,118

(22) PCT Filed: Jun. 20, 2007
(86) PCT No.: PCT/IB2007/052381

§ 371 Date: Aug. 11, 2009

(30) Foreign Application Priority Data
Jun. 21, 2006 (IT) MO2006A000202

(51) Int. Cl. B67D 7/32

(52) U.S. Cl. 141/192

(57) ABSTRACT

Safety device in a fuel dispensing nozzle having an internal tube and a fuel dispensing end. The device is able to prevent or interrupt the fuel supply in the event that the nozzle is not correctly inserted inside or connected to the inlet of a tank to be filled with fuel. The device includes at least one light sensor to be able to detect the light inside the tank.

### TECHNICAL FIELD

The present invention concerns a safety device for fuel dispensing nozzles, and in particular the present device, which is applicable to nozzles for dispensing liquid or gaseous fuel, for example petrol, gas oil, kerosene, liquid petroleum gas (LPG), methane, natural gas, hydrogen, etc., is envisaged in order to detect the correct insertion or connection of the nozzle into/with the fuel tank of a vehicle.

### PRIOR ART

At present safety devices able to check the correct insertion, or connection, of the nozzle into/with the tank of a vehicle are not available commercially. Known devices are based on geometrical and dimensional parts which define a unique combination between nozzle and tank inlet, for example complementary diameters and shapes of the nozzle dispensing tube and the tank inlet.

These devices are used to prevent the mistake of filling a vehicle with the wrong fuel: for example, filling a vehicle which requires diesel fuel with petrol.

Other devices known for example from the patents U.S. Pat. No. 6,522,947, U.S. Pat. No. 6,466,842 and U.S. Pat. No. 6,497,363 comprise electric or electronic devices such as electrical contacts, microchips, transponders, RFIDs (Radio Frequency Identification Devices), which allow electronic dialogue between the nozzle and the vehicle to be filled. In this case it is necessary, therefore, for the vehicle and in particular the vehicle tank inlet to be designed for such a dialogue and to comprise the necessary electrical and/or electronic components.

The safety devices according to the abovementioned patents have never found a practical application in the fuel dispensing nozzles which are normally used in filling stations. In fact, since the abovementioned devices require a corresponding design also on the vehicles, they would have required modification of all the vehicles in circulation, with obvious production and cost-related problems.

### DISCLOSURE OF THE INVENTION

An object of the present invention is therefore to improve the known safety devices for fuel dispensing nozzles.

Another object of the invention is to provide a safety device which is safe and reliable in terms of operation.

Another object of the invention is to provide a safety device which may be incorporated in an optimum manner in fuel dispensing nozzles, in particular electromechanically operated fuel dispensing nozzles.

Yet another object of the invention is to provide a safety device which is explosion-proof.

A further object of the present invention is to provide a safety device which is simple and inexpensive to manufacture.

According to one aspect of the present invention, a safety device is provided in a fuel dispensing nozzle having an internal tube and a fuel dispensing end, said device being able to prevent or interrupt the fuel supply in the event that said nozzle is not correctly inserted inside or connected to the inlet of a tank to be filled with fuel and comprising at least one sensor, characterized in that said sensor is a light sensor able to detect the light inside the tank.

Owing to the invention, the safety device is able to detect the correct insertion or connection of the nozzle inside/to the tank inlet in a precise and low-cost manner, without requiring specific special fittings, such as electric sockets, cables, microchips, etc., in the tank or in the tank inlet.

The dependent claims refer to preferred and advantageous embodiments of the invention.

### BRIEF DESCRIPTION OF THE DRAWINGS

Further objects and advantages of the present invention will become clearer from the following detailed description of certain preferred embodiments of the present invention, provided with reference to the accompanying drawings in which:

FIG. 1 is a side view, with parts cross-sectioned, of a fuel dispensing nozzle provided with the safety device according to the present invention;

FIG. 2 is a partially enlarged and cross-sectional view of another version of the safety device according to the present invention.

### EMBODIMENTS OF THE INVENTION

With reference to the accompanying drawings, a fuel dispensing nozzle is denoted overall by 1.

The nozzle 1 comprises an internal fuel dispensing tube 2 which has a safety device 10 according to the present invention inserted inside it; the nozzle 1 also comprises a fuel dispensing end 3 able to be inserted inside or connected to an inlet of a tank, for example a fuel tank of a vehicle.

The safety device 10 is intended to prevent or interrupt the fuel supply in the event that the nozzle 1 is not correctly inserted inside or connected to the inlet of the tank which is to be filled with fuel and comprises at least one light sensor 11 directed towards the end 3 of the nozzle 1. In order to increase the operating safety, the device 10 may comprise a plurality of light sensors 11 which, since they are more than one in number, may still ensure operation in the event of a defective sensor.

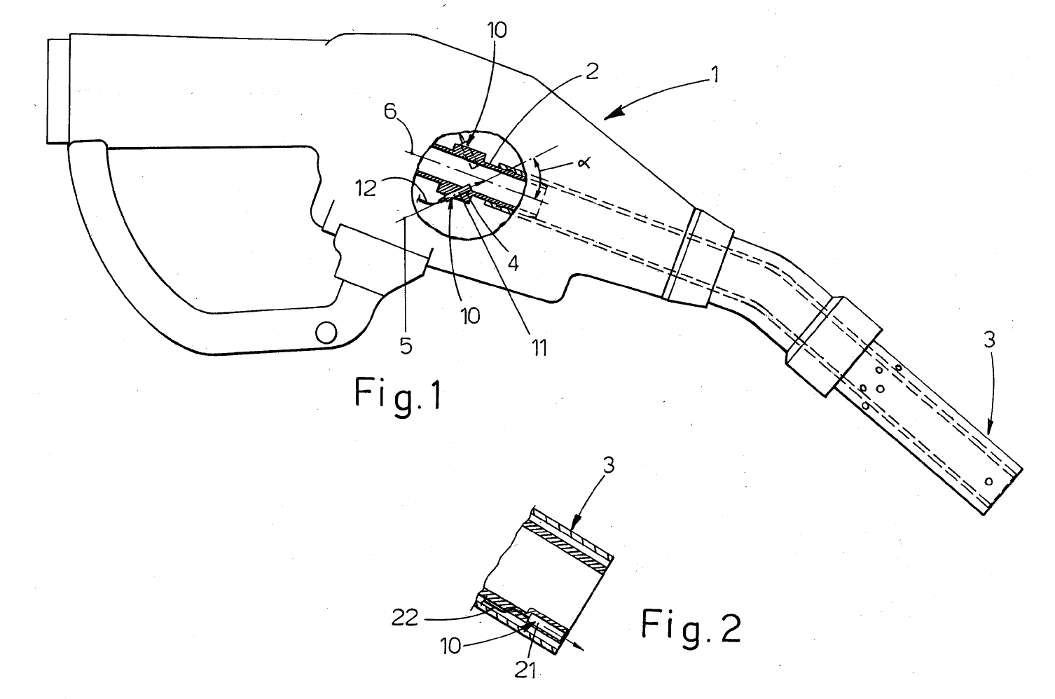

In accordance with that shown in FIG. 1, depending on the arrangement and the internal dimensions of the other components of the nozzle 1, such as, for example, the fuel dispensing valve (not shown), the device 10 with the sensor 11 may be inserted in the bottom part or in the top part of the internal fuel dispensing tube 2, inside a seat 4, which is formed in the internal tube 2. In the case of two sensors 11, these may be arranged at the top and at the bottom, as shown in FIG. 1.

Obviously, different positions of the sensor 11 inside the tube 2 are also possible: for example lateral, inclined, etc. The sensor 11 must have the sensitive part directed towards the end 3 so as to capture the light which may come from the end 3, which is open externally.

The seat 4 has an axis 5 with a certain angle α of inclination with respect to the axis 6 of the internal dispensing tube 2. The angle α of inclination may be between 30 and 60 degrees and in particular is about 45 degrees.

The abovementioned angles α of inclination are chosen so as to obtain the best sensing of any light from the end 3.

The sensor 11, which may be a photodiode or a photoresistor, is connected to the fuel dispensing valve or to a unit, where present, for controlling the fuel dispensing valve by means of a connection cable 12.

The sensor 11 may also comprise a logarithmic amplifier (not shown) able to amplify greatly the signals relating to the loss light values, the abovementioned logarithmic amplifier being able to be incorporated in the sensor 11 itself.

In the version shown in FIG. 2, the safety device 10 is situated inside the end 3 of the nozzle 1 where dispensing of the fuel occurs. This version is suitable for use, for example, in nozzles for dispensing gaseous fuel which have an attachment (not shown) for the tank inlet, which prevents light passing inside.

Also in this version, shown in FIG. 2, of the safety device 10 according to the present invention, the light sensor 11 is situated inside the nozzle 1, and the end 3 has an opening 21 able to receive the light from the outside and a transmission line 22 made, for example, of optical fibres.

In this way the light sensor 11 is protected against impacts and the transmission of electric signals which could be dangerous in the presence of fuels and which would therefore require special protection is avoided.

An important characteristic feature of the safety device 10 according to the present invention is the measurement of the reference light value, i.e. the light value, or rather the non-light or darkness value, which corresponds to insertion or connection of the end 3 inside/to the tank to be filled, in accordance with that described in greater detail below.

Since a tank, and in particular a fuel tank of a vehicle, is never completely dark and is subject to light from the outside environment, it is necessary to perform a reference light measurement which corresponds to the minimum light level, i.e. darkness level, for the local conditions in that moment. The abovementioned local light conditions depend mainly on the time when filling is performed, namely if filling is performed during the daytime when natural light is present or at night-time when artificial light is present, and to a lesser extent on the climatic and/or seasonal conditions, i.e. for example if the weather is very sunny or cloudy.

When the nozzle 1 is inserted into its seat in the fuel pump (not shown) and before the nozzle is removed, a light measurement which serves as a reference for subsequent light measurements is performed. The light measurement with the nozzle inserted in its seat in the fuel pump is precisely that which corresponds to the minimum light level, i.e. darkness level, for the local conditions at that time.

Therefore, once this reference light value has been stored, it is sufficient to compare the light value measured before dispensing of the fuel with the reference light measurement. If the two light values are comparable, i.e. if the light value measured is within certain limits more or less in the region of the reference light value measured previously, this means that the nozzle is correctly inserted or connected to the tank to be filled, and in this case the enable signal to start and/or continue dispensing fuel is emitted.

If, for any reason, the nozzle is disengaged or removed from the tank, the device 10 immediately detects an increase in the light level and supplies a signal for interrupting the fuel supply.

The safety device 10 according to present invention is easily incorporated in fuel dispensing nozzles provided with electromechanically operated dispensing valves since the wires and electric power supply required for the device 10 are already present.

However, the device 10 according to the present invention may also be usefully applied to nozzles provided with completely mechanical fuel dispensing valves, the said valves being provided with suitable electromechanical locking devices.

The safety device according to the present invention, by continuously detecting the correct insertion or connection of the nozzle inside/to the tank to be filled, avoids loss of fuel in the external environment. Moreover, since the safety device according to the present invention is based on light detection, it does not require that the tank or tank inlet be provided with complicated or costly special fittings, such as electric sockets, cables, microchips, etc.

Obviously, the present invention is not limited to the embodiments shown and described, but comprises all those variations and modifications suitable for achieving the same result and therefore falling within the wider scope of the inventive idea, substantially as described, illustrated and claimed.

In the claims, the reference numbers shown in brackets are purely indicative and do not limit the scope of protection of the said claims.

1-13. (canceled)

14. Safety device (10) in a fuel dispensing nozzle (1) having an internal tube (2) and a fuel dispensing end (3), said device (10) being able to prevent or interrupt a fuel supply in the event that said nozzle (1) is not correctly inserted inside or connected to the inlet of a tank to be filled with fuel and comprising at least one sensor (11), wherein said sensor (11) is a light sensor able to detect light inside the tank.

15. Safety device according to claim 14, in which said sensor (11) is directed towards the end (3) of the nozzle (1) inside a seat (4) formed in said internal tube (2).

16. Safety device according to claim 15, in which said seat (4) has an axis (5) and said internal tube (2) has an axis (6), said axis (5) and axis (6) having a certain angle (a) of inclination relative to each other of between 30 and 60 degrees.

17. Safety device according to claim 16, in which said angle (α) of inclination is about 45 degrees.

18. Safety device according to claim 14, in which said sensor (11) is inserted in tie bottom part or in the top part of the internal fuel dispensing tube (2).

19. Safety device according to claim 14, in which said sensor (11) is one of a photodiode and a photoresistor.

20. Safety device according to claim 14, in which said sensor (11) comprises a logarithmic amplifier able to amplify the signals relating to light values.

21. Safety device according to claim 14, in which said safety device (10) is situated inside the end (3) of the nozzle (1).

22. Safety device according to claim 21, in which said safety device (10) comprises an opening (21) able to receive ambient light and a transmission line (22) made of optical fibers.

23. Safety device according to claim 22, in which said safety device (10) has the light sensor (11) arranged inside the nozzle (1) and connected to the transmission line (22).

24. Safety device according to claim 14, in which the safety device (10) uses as a reference light value, a light value corresponding to the light value measured when the nozzle (1) is inserted inside its seat in the fuel pump.

25. Safety device according to claim 24, in which the sensor (11) emits an enable signal for starting and/or continuing the fuel supply, when the light value measured by the sensor (11) is within certain limits which are more or less in the region of the reference light value measured previously.

26. Safety device according to claim 14, in which said safety device (10) is connected to an electromechanically operated fuel dispensing valve.
